(19) United States
(12) Patent Application Publication
(10) Pub. No.: US 2007/0171433 A1
(43) Pub. Date: Jul. 26, 2007

(54) SYSTEMS AND PROCESSES FOR PROVIDING ENDOGENOUS MOLECULAR IMAGING WITH MID-INFRARED LIGHT

(75) Inventors: Guillermo J. Tearney, Cambridge, MA (US); Brett E. Bouma, Quincy, MA (US)

Correspondence Address: DORSEY & WHITNEY LLP;INTELLECTUAL PROPERTY DEPARTMENT, 250 PARK AVENUE, NEW YORK, NY, 10177, US

(73) Assignee: The General Hospital Corporation, Boston, MA (US)

(21) Appl. No.: 11/624,277

(22) Filed: Jan. 18, 2007

Related U.S. Application Data
(60) Provisional application No. 60/760,588, filed on Jan. 20, 2006.

(51) Int. Cl. G01B 11/14

(52) U.S. Cl. 356/614

(57) ABSTRACT

Exemplary systems and processes for generating information associated with at least one portion of a sample are provided. In one exemplary embodiment, at least one electromagnetic radiation can be received from the at least one portion, whereas the electromagnetic radiation has a wavenumber that is between approximately 5,000 cm⁻¹ and 600 cm⁻¹. The information can be generated which includes structural data, molecular data and/or chemical data of the portion. The information can be generated based on (a) at least one phase of the at least one electromagnetic radiation, and/or (b) at least one refractive index of the at least one portion. According to another exemplary embodiment, the electromagnetic radiation having a first wavenumber can be transmitted to the portion which has at least two substances, whereas a refractive index of one of the substances at a second wavenumber is approximately the same as a refractive index of another one of the substances at the second wavenumber. The electromagnetic radiation can be controlled such that the first wavenumber substantially matches the first wavenumber to reduce scattering within the portion.

### CROSS-REFERENCE TO RELATED APPLICATION(S)

This application is based upon and claims the benefit of priority from U.S. Patent Application Ser. No. 60/760,588, filed on Jan. 20, 2006, the entire disclosure of which is incorporated herein by reference.

### FIELD OF THE INVENTION

The present invention relates generally to optical imaging, and more particularly to a method, arrangement and system for performing optical imaging of scattering and phase phenomena in the mid-infrared (MIR) portion of the electromagnetic spectrum, e.g., with wavenumbers ranging from 600 cm⁻¹ to 5000 cm⁻¹.

### BACKGROUND INFORMATION

Gaining knowledge of biology at the molecular level may be one of the important challenges of the post-genomic era. While the development and application of fluorescent molecular probes may continue to provide the basis for many future advancements, there is a considerable need to address molecular characterization from an endogenous contrast alone. Endogenous-contrast molecular imaging may have the following exemplary advantages: a) it is non-destructive and generally does not alter the molecular composition of the specimen, b) specimen preparation is less substantial or nonexistent, c) knowledge of molecular structure is not required a priori, d) many unknown proteins/molecules may be studied simultaneously, e) biodistribution and delivery are not at issue, and f) techniques may be more easily translated to investigation and diagnosis of human tissues in vivo. Endogenous contrast approaches that determine structure, location, and function of molecules may therefore offer a clear window for observing natural biological processes.

Mid-infrared (MIR; 2 16 μm, 5000-600 cm-1) light may be preferable for endogenous chemical characterization since it can probe many native molecular vibrations simultaneously, with a high degree of specificity. To date, however, physical constraints and technological shortcomings may limit MIR molecular concentration sensitivities and imaging resolutions. Vibrational spectroscopies, including Raman and mid-infrared (e.g., MIR, 2-12 μm) are exemplary tools for an endogenous chemical characterization.

Studies have been conducted to investigate the potential of Fourier transform infrared (“FTIR”) spectroscopy and microscopy to obtain the chemical composition of proteins, biomembranes, cells, and diseased human tissue. However, MIR imaging remains a relatively unexplored area for biological samples and tissues for a number of reasons, some of which include: a) high absorption of water in mid-infrared, b) lack of high-resolution, high-sensitivity detectors and high-brightness sources that span the fingerprint regions, c) inadequate imaging optics, and d) complexity of biological spectra. One of the objects of the exemplary embodiments of the present invention is to leverage its signal-to-noise advantages for high-sensitivity molecular imaging and microscopy.

Accordingly, it may be beneficial to address and/or overcome at least some of the deficiencies described herein above.

### SUMMARY OF THE INVENTION

The exemplary embodiments of the present invention can overcome the above-described impediments to the MIR imaging, e.g., by utilizing MIR spectral changes in refractive index to obtain chemical information from tissue or biological specimens. For example, exemplary embodiments of the present invention described herein below describe various exemplary methods, arrangements and systems (e.g., which can use the MIR technology) to achieve molecular characterization in unlabeled samples with higher spatial resolutions and at much lower molecular concentrations than previously thought to be possible. It may therefore provide the ability to perform, e.g., multiplexed, sub-cellular mapping of low concentration molecules in unlabeled and unaltered specimens.

The mainstay of mid-infrared analysis is absorption spectroscopy, which can provide information on molecular vibrations through measurements of wavelength-dependent attenuation of light. Absorption, however, is only one component of the complex index of refraction, the quantity that describes in detail the interaction of light with matter. However, techniques based on wavelength-dependent refractive index fluctuations have been relatively unexplored. Occurring in the vicinity of molecular absorption transitions, these rapid changes in refractive index can affect wavelength-dependent phase and scattering, which are in turn controlled by the molecular composition of the sample.

These optical phenomena may be probed in unlabeled specimens with highly sensitive mid-infrared phase and scattering measurement techniques. In so doing, detailed spectra of molecular species can be obtained in situ at much lower concentrations than any other method available today. When combined with certain techniques for improving the resolution of mid-infrared microspectroscopy, phase/scattering imaging may provide detailed sub-cellular maps of protein and metabolite composition. Since these mid-infrared signatures can be measured in a backscattering geometry, they may be obtained from thick tissue specimens, making endogenous-contrast molecular imaging in living animals and human patients possible.

Accordingly, exemplary systems and processes for generating information associated with at least one portion of a sample are provided. In one exemplary embodiment, at least one electromagnetic radiation can be received from the at least one portion, whereas the electro-magnetic radiation has a wavenumber that is between approximately 5,000 cm⁻¹ and 600 cm⁻¹. The information can be generated which includes structural data, molecular data and/or chemical data of the portion. The information can be generated based on (a) at least one phase of the at least one electromagnetic radiation, and/or (b) at least one refractive index of the at least one portion. The above exemplary procedures can be provided by at least one arrangement.

In another exemplary embodiment of the present invention, the information can be generated based on at least one refractive index gradient of the portion. A wave guide arrangement (e.g., a mirror tunnel arrangement) can be provided which is adapted to transmit the electromagnetic radiation to the arrangement. The arrangement can include an interferometric arrangement (e.g., a common path interferometric arrangement) which may receive at least the electromagnetic radiation which can be based on a radiation received from a sample arm and a radiation received from a reference arm. The interferometric arrangement can utilize a multiple-beam interferometric arrangement and/or an active stabilization technique. The electromagnetic radiation can pass through the portion a plurality of times.

In yet another exemplary embodiment of the present invention, the arrangement can receives the electromagnetic radiation from a confocal microscopy arrangement, a spatial filter class, dark-ground, phase-contrast, and diffraction-contrast microscopy arrangement, a Nomarski or differential interference contrast microscopy arrangement, and/or a multi-focus radiative transport of intensity equation microscopy arrangement. An image of the at least one portion can be generated based on the information. The image can be generated using a computed tomography technique. The image can be a two-dimensional image and/or a three-dimensional image. The sample may include a biological sample. The biological sample can be an anatomical structure. At least one image of the at least one of the structural, molecular or chemical data of the portion can be generated based on at least one mathematical operation on one or more of data associated with one or more wave numbers.

According to another exemplary embodiment, the electromagnetic radiation having a first wavenumber can be transmitted to the portion which has at least two substances, whereas a refractive index of one of the substances at a second wavenumber is approximately the same as a refractive index of another one of the substances at the second wavenumber. The electro-magnetic radiation can be controlled such that the first wavenumber substantially matches the first wavenumber to reduce scattering within the portion.

Other features and advantages of the present invention will become apparent upon reading the following detailed description of embodiments of the invention, when taken in conjunction with the appended claims.

### BRIEF DESCRIPTION OF THE DRAWINGS

Further objects, features and advantages of the present invention will become apparent from the following detailed description taken in conjunction with the accompanying figures showing illustrative embodiments of the present invention, in which:

FIG. 1 is a schematic diagram of an exemplary embodiment of a waveguide microscope;

FIG. 2 is a graph of exemplary absorption characteristics of a water substance (shown as a darker line) and a lipid-based substance (shown as a lighter line);

FIG. 3 is a graph of exemplary refractive index characteristics of a water substance (shown as a darker line) and a lipid-based substance (shown as a lighter line);

FIG. 4 is a schematic diagram of an exemplary embodiment of a MIR OCPM apparatus according to the present invention; and

FIG. 5 is a graph of an exemplary normalized scattering cross-section for a 1 μm lipid sphere immersed in water (e.g., determined using Mie theory).

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF EXEMPLARY EMBODIMENTS

An exemplary embodiment of a system according to the present invention can utilize a light source irradiating a specimen with MIR light. The sample can absorb, scatter, transmit or reemit the light. According to one exemplary embodiment of the present invention, scattering of light from the specimen can be detected and analyzed. In another exemplary embodiment of the present invention, the phase of the light transmitted or remitted from the specimen can be detected. In a further exemplary embodiment of the present invention, the intensity of light as it is transmitted through or remitted by the specimen can be detected and analyzed.

The scattering, phase, and transmission of a specimen may be affected by the refractive index of the specimen or refractive index heterogeneities or refractive index gradients therein. MIR wavelengths may be selected or controlled or MIR spectroscopy may be conducted to probe these refractive index changes by measuring scattering, phase, and absorption. The refractive index changes are related to the molecular and chemical composition of the sample, and therefore, the measurement of phase, scattering, and transmission can provide this information. These measurements may be conducted using a microscopic instrument, providing high spatial resolution images of molecular composition, or may be conducted using a macroscopic instrument that measures a low-resolution image of the specimen or the bulk properties of the specimen.

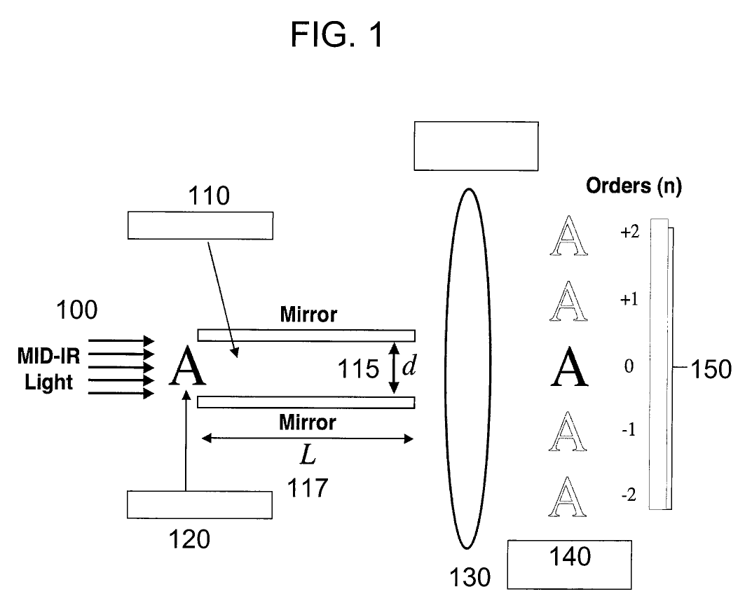

Conventional implementations of MIR microscopy may be less beneficial since they generally have small fields of view and relatively low spatial resolutions. A variety of technical issues can be reviewed such as, e.g., a small number and large size of pixels available in HgCdTe focal plane arrays (FPA), a lack of accessible high-brightness sources, and a relatively low numerical aperture (NA<0.6) of MIR reflective objectives, some or all of which can make a wide-field sub-cellular imaging difficult. In order to address the challenges of full-slide digital histopathology imaging, another exemplary embodiment of the present invention can provide a wide-field microscopy technique to be utilized in devices and processes that can use a multi-mode rectangular waveguide or mirror tunnel 110 as the objective lens (shown in FIG. 1)

FIG. 1 shows a schematic diagram of an exemplary embodiment of a waveguide microscope. For simplicity of presentation, only two mirrors are shown in FIG. 1. However, it may be preferable to use three, four or more mirrors to fully confine the spatial modes in two-dimensions. Following an MIR illumination 100 of a specimen 120, a diffracted light can propagate through the waveguide or mirror tunnel 110. The lowest diffraction order can pass directly through the waveguide, whereas higher (n) orders may reflect off the mirrors n-times. If a lens 130 is placed at the output of the waveguide/mirror tunnel 110, an array of images can be formed on the image plane 140, where each successive image 150 of order (n=0,±1,±2 . . . ) can be formed from a spatially band passed version of the original image with low-pass cutoff <(n−1) and high-pass cutoff <(n) defined approximately by, e.g.,:

$$α ( n ) = k sin [ {tan}^{- 1} [ \frac{( 2 n + 1 ) d}{2 L} ] ] .$$

where d is a distance 115 between the two mirrors 115, L is a length 117 of the waveguide 110 and k is a wavenumber.

Following the detection of the amplitude and phase of each band passed image, the original image can be reconstructed at full-resolution by coherent addition of the band passed images. To mitigate cost and complexity, each band passed image can be deflected onto a single FPA, and its amplitude and phase can be obtained in a serial fashion. Using this exemplary technique, large field of view, megapixel images can be recreated on a 64×64 pixel FPA without moving the specimen. A resolution can also be improved as the mirror tunnel behaves like a diffraction-limited reflective objective lens with a NA nearly equal to the refractive index of the waveguide. When filled with water, the theoretical spatial resolution of the mirror tunnel ranges from ˜1.5-6.0 μm in the fingerprint region (3600 -800 cm⁻¹), which is approximately a factor of four better than that of commercially available FPA infrared microscopes. As opposed to micro-Attenuated Total Reflection (“ATR”) microscopy, which provides comparable resolution, the water-filled mirror tunnel does not require specimen contact, and is therefore much more amenable to imaging live cells. If contact is permissible, the same principles of micro-ATR can be applied by constructing the mirror tunnel from a high-index waveguide (e.g. Germanium) to provide ˜0.5-2.0 μm spatial resolution throughout the fingerprint region.

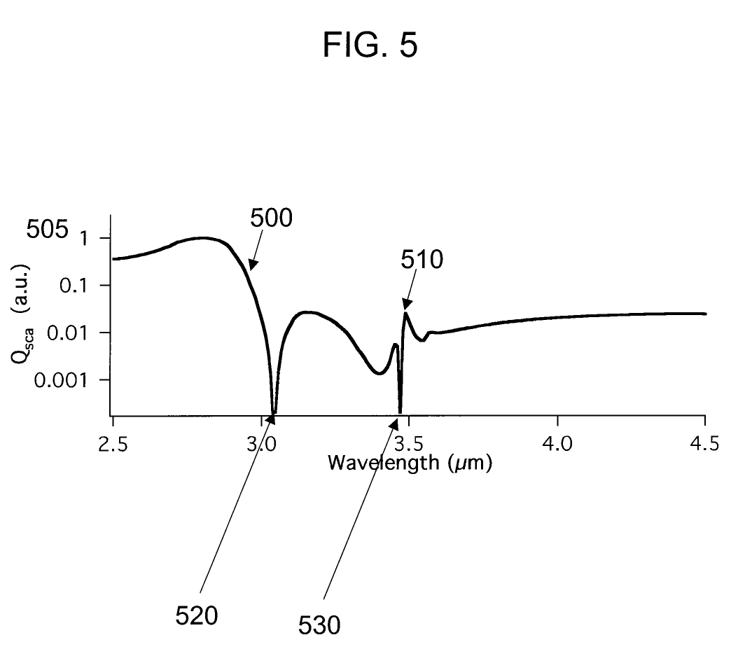

Waveguide microscopy can be used for absorption spectroscopy at preferential spatial resolutions. While useful for determining functional groups, the amount of chemical information that can be obtained from absorption signatures may be limited in part by absorption signatures of dominant molecules, such as water, which tend to overwhelm the spectral contribution of molecules at lower concentrations. The inherent refractive index change that takes place at absorption fundamental wavelengths can be analyzed. This change in the refractive index may result in a phase or scattering modulation of the infrared signal at characteristic wavelengths corresponding to vibrational transitions (see graph of FIG. 5). Unlike absorption features, phase and scattering signatures can be more easily detected, since the unwanted background can be removed optically to reveal smaller molecular perturbations. Furthermore, the detected spectral features would likely be sharper, similar to derivative spectra. For visible microscopy, phase and scattering can be commonly exploited to image unstained samples by several conventional microscopy techniques, including, e.g.,: a) the spatial filter class: dark-ground, phase-contrast, and diffraction-contrast microscopy, b) Nomarski or differential interference contrast microscopy (“DIC”), and c) multi-focus radiative transport of intensity equation microscopy. When applied in the mid-infrared and in conjunction with waveguide microspectroscopy, these exemplary phase and scattering-sensitive techniques can enable imaging of endogenous, subcellular molecular features at lower concentrations than that possible by conventional MIR microspectroscopy methods.

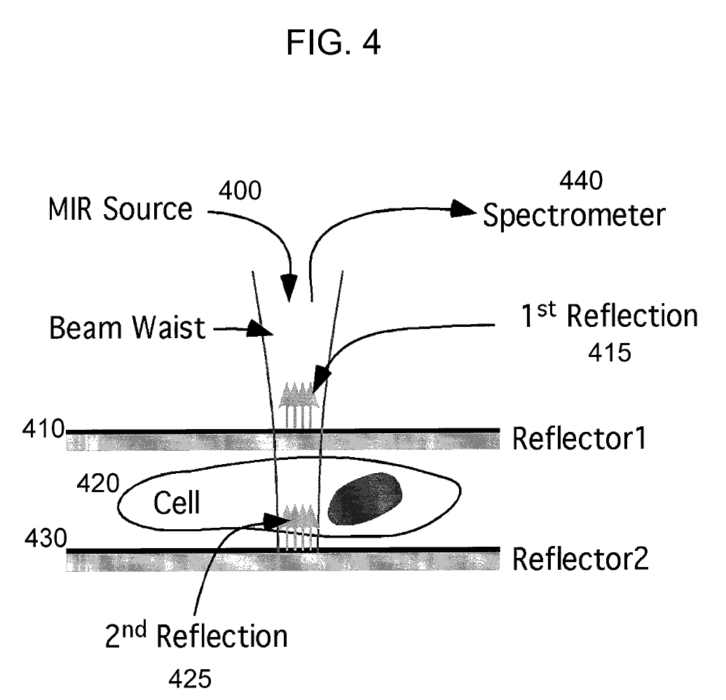

The exemplary embodiments of the microscopies according to the present invention as described herein above may improve the sensitivity of endogenous molecular characterization by eliminating background, e.g., but for proteins and metabolites at very low concentrations, the phase and scattering perturbations may still be below the limits of direct detection. When applied in the mid-infrared, the exemplary embodiments of quantitative interferometric techniques according to the present invention—termed “optical coherence phase microscopy” (“OCPM”) herein—may allow endogenous imaging of phase changes induced by nanomolar concentrations of molecules in living cells. One exemplary variant of OCPM can use common-path interferometry to measure the electric field cross-correlation between a reflector above and a reflector below the sample (see FIG. 4). In the exemplary illustration of FIG. 4, MIR light 400 irradiates a cell 420 positioned between two reflectors, i.e., reflector 1 410 and reflector 2 430. MIR light 400 is reflected off the reflector 1 410, the cell 420, and the reflector 2 430. Reflected light from the cell, e.g., the reflected light from the first reflector 415 and reflected light from the second reflector 425 are detected by a spectrometer. The spectrometer can detect the interference as a function of wavenumber. When the spectral interference of the returned light is measured, the phase relationship between the light transmitted through the sample and the reference light may be determined with extremely high precision, on the order of <0.1 μrad. If a 10 μm cell path length is considered, a refractive index change of 5×10⁻⁹ can therefore be detectable by OCPM.

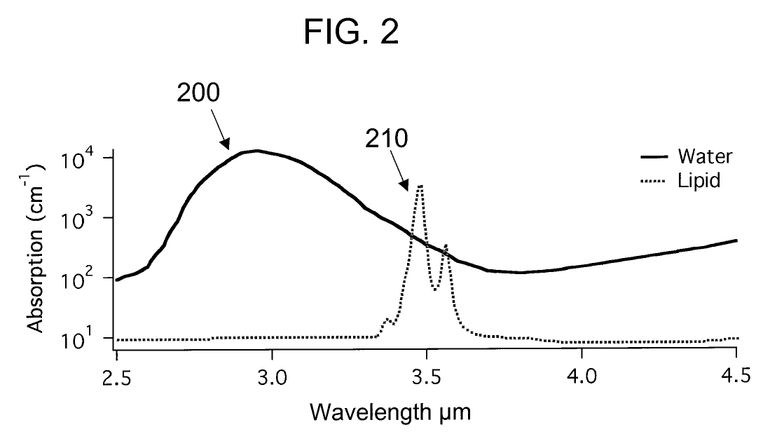

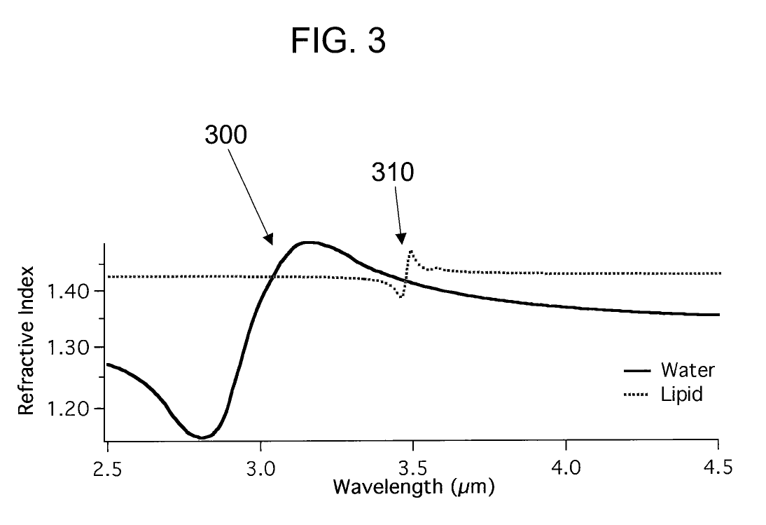

FIG. 2 shows a graph of exemplary absorption characteristics of a water substance (shown as a darker line 200) and a lipid-based substance (shown as a lighter line 210). FIG. 3 shows a graph of exemplary refractive index characteristics of a water substance (shown as a darker line 300) and a lipid-based substance (shown as a lighter line 310). In the exemplary graphs of FIGS. 2 and 3, where the lipid absorption signature (CH₂ stretch) of the lipid-based substance 210 arises from approximately 0.5 molar oleic acid, a rapid refractive index fluctuation of the lipid-based substance 310 of ˜0.1 around 3.5 μm (2850 cm⁻¹) can be seen. As a result, it is possible to detect ˜25 nmol oleic acid via the OCPM technique at this mid-infrared transition.

Further enhancements, including the use of 3-beam interferometry, multiply passing the specimen, high-power/brightness sources, or active stabilization techniques, could enable microscopic imaging with endogenous molecular sensitivities in the picomolar range. Mid-infrared OCPM can also be conducted in conjunction with waveguide microscopy (e.g., using the exemplary system/arrangement of FIG. 1) for a high-sensitivity imaging of subcellular proteins. The large field of view of the waveguide microscope opens up an additional possibility of using OCPM for endogenous, high-throughput detection of proteins on live cell and tissue microarrays.

The phase changes in the mid-IR may facilitate a better observation of molecular scattering in thick tissues. FIG. 5 shows a graph of an exemplary wavelength dependent normalized scattering cross-section (Q_{sca}) 505 for a 1 μm diameter lipid sphere in water. Certain features may be seen in this shown scattering spectrum. For example, optical scattering by this particle fluctuates by many orders of magnitude in the vicinity of water 500 and lipid 510 absorption peaks. The nature of this fluctuation is specific for a given solute and could form a basis for recovering the chemical composition of a thick tissue sample in back reflection. By using high-brightness sources and heterodyne interferometry, individual large organelles such as nuclei, mitochondria, vesicles, lysozomes, and mmolar concentrations of macromolecules may be detected, which may be important for a non-invasive optical diagnosis. This is substantiated supported by a recent report demonstrating information-rich, but as of yet, poorly understood FPA MIR images from tissue at 100-200 μm depths [see Wang et al., J. Biomed. Optics. 12:208 (2004)]. Further, at two distinct wavelengths in the mid-IR (3.04 μm 520 and 3.48 μm 530), the refractive index of lipid and water can equalize. At these index-crossing wavelengths, the normalized scattering cross-section approaches zero. Therefore, at these wavelengths, optical losses would likely be due to absorption alone. This phenomenon can be utilized in many ways, including, e.g., a) to construct images of individual molecular vibrations by subtracting images obtained at index-crossing wavelengths from images acquired at adjacent frequencies, and b) to conduct absorption tomography of water-based organisms (e.g., developing embryos) near the optical diffraction limit.

The foregoing merely illustrates the principles of the invention. Various modifications and alterations to the described embodiments will be apparent to those skilled in the art in view of the teachings herein. Indeed, the arrangements, systems and methods according to the exemplary embodiments of the present invention can be used with and/or implement any OCT system, OFDI system, SD-OCT system or other imaging systems, and for example with those described in International Patent Application PCT/US2004/029148, filed Sep. 8, 2004, U.S. patent application Ser. No. 11/266,779, filed Nov. 2, 2005, and U.S. patent application Ser. No. 10/501,276, filed Jul. 9, 2004, the disclosures of which are incorporated by reference herein in their entireties. It will thus be appreciated that those skilled in the art will be able to devise numerous systems, arrangements and methods which, although not explicitly shown or described herein, embody the principles of the invention and are thus within the spirit and scope of the present invention. In addition, to the extent that the prior art knowledge has not been explicitly incorporated by reference herein above, it is explicitly being incorporated herein in its entirety. All publications referenced herein above are incorporated herein by reference in their entireties.

What is claimed is:

1. A system for generating information associated with at least one portion of a sample, comprising:
at least one arrangement which is configured to:
i) receive at least one electromagnetic radiation from the at least one portion, wherein the at least one electromagnetic radiation has a wavenumber that is between approximately 5,000 cm⁻¹ and 600 cm⁻¹, and
ii) generate the information which includes at least one of structural data, molecular data or chemical data of the at least one portion, wherein the at least one arrangement generates the information based on at least one of (a) at least one phase of the at least one electromagnetic radiation, or (b) at least one refractive index of the at least one portion.

2. The system according to claim 1, wherein the at least one arrangement generates the information based on at least one refractive index gradient of the at least one portion.

3. The system according to claim 1, further comprising a wave guide arrangement which is adapted to transmit the at least one electromagnetic radiation to the at least one arrangement.

4. The system according to claim 3, wherein the wave guide arrangement is a mirror tunnel arrangement.

5. The system according to claim 1, wherein the at least one arrangement comprises an interferometric arrangement which receives at least the at least one electromagnetic radiation which is based on a radiation received from a sample arm and a radiation received from a reference arm.

6. The system according to claim 5, wherein the interferometric arrangement includes a common path interferometric arrangement.

7. The system according to claim 5, wherein the interferometric arrangement utilizes at least one of a multiple-beam interferometric arrangement or an active stabilization technique.

8. The system according to claim 5, wherein the at least one electromagnetic radiation passes through the at least one portion a plurality of times.

9. The system according to claim 1, wherein the at least one arrangement receives the at least one electromagnetic radiation from at least one of (a) a confocal microscopy arrangement, (b) a spatial filter class, dark-ground, phase-contrast, and diffraction-contrast microscopy arrangement, (c) a Nomarski or differential interference contrast microscopy arrangement, or (d) a multi-focus radiative transport of intensity equation microscopy arrangement.

10. The system according to claim 1, wherein the at least one arrangement is further configured to generate an image of the at least one portion based on the information.

11. The system according to claim 10, wherein the image is at least one of a two-dimensional image or a three-dimensional image.

12. The system according to claim 1, wherein the sample includes a biological sample.

13. The system according to claim 12, wherein the biological sample is an anatomical structure.

14. The system according to claim 1, wherein the at least one arrangement is further configured to generate at least one image of the at least one of the structural, molecular or chemical data of the at least one portion based on at least one mathematical operation on one or more of data associated with one or more wave numbers.

15. A system for generating information associated with at least one portion of a sample, comprising:
at least one arrangement which is configured to:
i) transmit at least one electromagnetic radiation having a first wavenumber to the at least one portion which has at least two substances, wherein a refractive index of one of the substances at a second wavenumber is approximately the same as a refractive index of another one of the substances at the second wavenumber,
ii) control the at least one electromagnetic radiation such that the first wavenumber substantially matches the first wavenumber to reduce scattering within the at least one portion, and
iii) generate the information which includes at least one of structural data, molecular data or chemical data of the at least one portion.

16. The system according to claim 15, wherein the at least one arrangement generates the information based on at least one of (a) at least one phase of the at least one electromagnetic radiation, or (b) at least one absorption of the at least one portion.

17. The system according to claim 15, wherein the at least one electromagnetic radiation has at least one of the first wavenumber or the second wavenumber that is between approximately 5,000 cm⁻¹ and 600 cm⁻¹.

18. The system according to claim 15, wherein the at least one arrangement comprises an interferometric arrangement which receives at least the at least one electromagnetic radiation which is based on a radiation received from a sample arm and a radiation received from a reference arm.

19. The system according to claim 15, wherein the at least one arrangement receives the at least one electromagnetic radiation from at least one of (a) a confocal microscopy arrangement, (b) a spatial filter class, dark-ground, phase-contrast, and diffraction-contrast microscopy arrangement, (c) a Nomarski or differential interference contrast microscopy arrangement, or (d) a multi-focus radiative transport of intensity equation microscopy arrangement.

20. The system according to claim 15, wherein the at least one arrangement is further configured to generate an image of the at least one portion based on the information.

21. The system according to claim 20, wherein the image is at least one of a two-dimensional image or a three-dimensional image.

22. The system according to claim 20, wherein the at least one arrangement is configured to generate the image using a computed tomography technique.

23. The system according to claim 15, wherein the sample includes a biological sample.

24. The system according to claim 24, wherein the biological sample is an anatomical structure.

25. The system according to claim 11, wherein the at least one arrangement is further configured to generate at least one image of the at least one of the structural, molecular or chemical data of the at least one portion based on at least one mathematical operation on one or more of data associated with one or more wave numbers.

26. A process for generating information associated with at least one portion of a sample, comprising:
receiving at least one electromagnetic radiation from the at least one portion, wherein the at least one electromagnetic radiation has a wavenumber that is between approximately 5,000 cm⁻¹ and 600 cm⁻¹; and
generating the information which includes at least one of structural data, molecular data or chemical data of the at least one portion, wherein the information is generated based on at least one of (a) at least one phase of the at least one electromagnetic radiation, or (b) at least one refractive index of the at least one portion.

27. A process for generating information associated with at least one portion of a sample, comprising:
transmitting at least one electromagnetic radiation having a first wavenumber to the at least one portion which has at least two substances, wherein a refractive index of one of the substances at a second wavenumber is approximately the same as a refractive index of another one of the substances at the second wavenumber;
controlling the at least one electromagnetic radiation such that the first wavenumber substantially matches the first wavenumber to reduce scattering within the at least one portion; and
generating the information which includes at least one of structural data, molecular data or chemical data of the at least one portion.
